(19) United States
(12) Patent Application Publication
(10) Pub. No.: US 2024/0396414 A1
(43) Pub. Date: Nov. 28, 2024

(54) Device, machine and method for producing a final configuration of conductor elements

(71) Applicant: Gehring Technologies GmbH + Co. KG, Ostfildern (DE)

(72) Inventors: Theodor Hüttner, Notzingen (DE); Sebastian Scheeff, Esslingen (DE)

(21) Appl. No.: 18/695,271

(22) PCT Filed: Sep. 6, 2022
(86) PCT No.: PCT/EP2022/074730

§ 371 Date: Mar. 25, 2024

(30) Foreign Application Priority Data
Oct. 14, 2021 (DE) 10 2021 126 719.6

(51) Int. Cl. H02K 15/04; H02K 15/06

(52) U.S. Cl. CPC H02K 15/0428; H02K 15/064

(57) ABSTRACT

The invention relates to an apparatus (10) for producing an in particular circular final configuration (12) of conductor elements (14), preferably hairpins, which are designed in particular with a rectangular conductor cross-section, for fitting a stator core, wherein each conductor element (14) has at least one, in particular two, limbs (16). The invention also relates to a corresponding machine (58) and to a corresponding method.

The invention relates to an apparatus for producing an in particular circular final configuration of conductor elements, preferably hairpins, which are designed in particular with a rectangular conductor cross-section. The final configuration of the hairpins is provided for fitting a stator core. Each conductor element has at least one, in particular two, limbs. The apparatus in question has the features of claim 1, and a machine also according to the invention is designed with the features of claim 10. The invention further relates to a method for producing an in particular circular final configuration of conductor elements, having the features of claim 12.

Apparatuses and methods for producing a final configuration of conductor elements for fitting a stator core are known in the prior art. Stators are used, for example, in electrodynamic machines, e.g. in electric motors. In the production of electromechanical transducers, in particular electric motors, in particular for traction drives, individual winding elements (plug-in coils, so-called “hairpins”) are produced, which are further processed into a stator winding during the further process. For this purpose, the individual conductor elements or hairpins are combined to form a final configuration, and inserted into the stator core, are frequently deformed in the stator core (twisted), and subsequently are welded to one another, so that the individual conductor elements form the windings of the stator.

A hairpin in the present sense is a conductor element with two elongated limbs which are connected via a connection portion. Hairpins are often substantially U-shaped. The connection portion (also referred to as connecting limb) can be designed to be arcuate; however, it can also be designed to be straight or step-shaped in portions. As in the case of the hairpin just described, a conductor element can have two elongated limbs. However, a conductor element can also be a special pin which only has a single elongated limb. Such so-called special pins are usually inserted in addition to hairpins (conductor elements with two limbs) into the stator core. Such special pins (conductor elements with one limb) typically have an elongated shape.

US 2018/0 233 995 A1 and EP 2 874 289 A1 each disclose an apparatus for producing a final configuration of conductor elements. However, the design of both apparatuses is very complex. Changes in a final configuration of conductor elements into another final configuration (e.g. with a different diameter and/or with other conductor elements) can only be implemented to a very limited degree, and only by extensive modifications of the respective apparatuses. Likewise, the addition of special pins is either not possible—or only to a limited extent.

The object of the present invention is to provide a possibility for producing an in particular circular final configuration of conductor elements, wherein the above disadvantages are eliminated, and the creation of the final configuration is in particular flexible.

This object is achieved by an apparatus having the features of claim 1. The device comprises:

At least two holding segment devices, wherein each holding segment device has at least one holding segment unit. Each holding segment unit is configured to receive the limbs of a plurality of conductor elements, and to hold them in an intended orientation, and to transfer them into the final configuration by moving the holding segment unit. In particular, all limbs of a conductor element in the holding segment unit are held in the holding segment unit. Therefore, for a hairpin, both elongated limbs leading away from the connection portion are held. In other words, each conductor element is held and moved in particular by all its limbs. The apparatus is in particular designed such that the orientation or alignment of the conductor elements is not changed during the movement.

The holding segment units are arranged in a starting position at a corresponding first radial distance from a center point. In the present case, a radial distance means the distance between a holding segment unit and the center point (i.e., the shortest distance between the holding unit and the center point). In this case, the radial distance is measured from a point on/of the holding segment unit to the center point. The point from which the distance to the center point is measured can be, for example, the geometric center of the holding segment unit, or a point arranged on the holding segment unit and located closest (or furthest) to the center point. In particular, the radial distance for all of the holding segment units is measured to the center point from the same point.

Each of/The holding segment units can have different radial distances from the center point in the starting position. In particular, the holding segment units can be arranged on a first circular path (i.e., at the same first radial distance from the center point) around the center point. It is also conceivable that the holding segment units can each be arranged at a different radial distance from the center point.

The holding segment units are arranged in a final position on a second circular path around the center point. In other words, the holding segment units are arranged in the final position at a corresponding second radial distance from the center point, wherein the second radial distance of all the holding segment units is the same size. The holding segment units form a circle around the center point.

Each holding segment unit is designed to be movable in the apparatus along an at least partially straight and/or at least partially curved movement path between the starting position and the final position. The apparatus is designed in such a way that the conductor elements held in each holding segment unit are moved from the starting position into the final position during operation of the apparatus. In particular, the apparatus can be designed such that the conductor elements held in each holding segment unit are moved by an exclusively straight translational movement. This represents a particularly preferred variant in which the mechanism for implementing the movement can be designed to be simple, and the apparatus works particularly reliably and is structurally simple to implement. In particular, all limbs of each held conductor element are moved in a straight line.

The apparatus is designed such that the movement paths of the holding segment units run tangentially to a third circular path around the center point, or through the center point. In an apparatus having at least three holding segment units, the holding segment units are moved on movement paths of the holding segment units tangential to a third circular path around the center point. In other words, the movement paths do not run through the center point. In an apparatus having two holding segment units, the holding segment units are moved on movement paths of the holding segment units through the center point.

In particular, the radius of the first, second and third circular paths is (always) greater than zero.

The holding segment units can each be fitted with hairpins and/or special pins. Different final configurations of the conductor elements can be realized, for example, by varying the movement paths of the holding segment units and/or replacing holding segment units with other (differently configured or differently designed) holding segment units. In particular, final configurations of the conductor elements with different diameters can be realized.

Each holding segment device can comprise a first guide element and a second guide element. In this case, the corresponding holding segment unit can be arranged in the starting position between the first guide element and the second guide element. The first and the second guide elements can be configured in such a way that the conductor elements are guided at least partially through the guide elements during the fitting of the corresponding holding segment unit in the starting position. In other words, by means of the first and the second guide element, in particular a guided fitting (insertion of the limbs of the conductor elements into the holding segment unit) of the holding segment unit is possible. The guide elements thus offer an insertion aid for inserting the conductor elements into their desired position. For example, the guide elements can have a centering effect toward the desired position.

The first and the second guide element can fix the holding segment unit during the fitting. The fixing of the holding segment unit by means of the first and the second guide element allows in particular an exact insertion of the limbs of the conductor elements into the holding segment unit (fitting). The fixing can take place in particular via a retaining clamping of the holding segment unit between the first and the second guide element.

The second guide element can be arranged on the side of the holding segment unit facing the center point. The second guide element can be designed so as to be movable, in particular pivotable, in such a way that it can be moved between a fitting position and a release position.

In particular, the second guide element can be configured so as to be movable away from the holding segment unit (in particular, pivoted away). In this case, the second guide element can fix the holding segment unit in the fitting position. In the fitting position, the second guide element can form a guide for the conductor elements to be fitted. In the release position, the second guide element can be arranged in such a way that a movement of the holding segment unit into its final position is possible.

The second guide element can be formed in one piece or in multiple pieces. It is conceivable that in the case of a multipart second guide element, the individual partial elements can be designed to be movable in different directions. For example, in the case of a second guide element designed in two pieces, a first partial element can be designed to be pivotable about a pivot axis and a second partial element can be designed to be pivotable about a second pivot axis (different from the first pivot axis).

The first guide element can be arranged on the side of the holding segment unit facing away from the center point. The first guide element can be designed to be movable, in particular analogously to the second guide element. The first guide element can be fixedly arranged and/or designed to be immovable.

In particular, the first guide element, the second guide element and/or the holding segment unit can have an arc-like shape. In any case, the side formed for contacting the holding segment unit can be designed to be arcuate and complementary to the holding segment unit.

Each holding segment device can comprise at least one guide device, in particular in the form of a guide rail, for the guided movement of the holding segment unit along the movement path. In other words, each holding segment unit can be guided along the movement path by means of the guide device, in particular between its starting position and its final position.

Each holding segment unit can have a plurality of receptacles for receiving limbs, in particular limb ends, of a conductor element. In particular, all limbs of a conductor element can be held in the receptacles.

The holding segment unit can be comb-like. Each receptacle can be arranged between two adjacent comb teeth in this case. In particular, each receptacle is designed like a pocket. In particular, each receptacle can have five (in particular flat) walls, which spatially delimit the corresponding receptacle. In this case, two, in particular three, adjacent walls of the same receptacle can each be arranged orthogonally to one another.

The comb teeth can be designed to taper in a direction facing away from the comb spine (direction away from the holding segment unit) and/or have a tapering portion.

Each holding segment unit can have at least one guide edge. The guide edge can be configured to at least partially guide and center the conductor elements to be inserted into the holding segment unit during the fitting of the holding segment unit. The guide edge can in particular have a beveled shape, in particular in the direction of the center between two adjacent comb teeth. The guide edge can be designed to be rounded. It is also conceivable for the guide edge to have sharp edges.

The guide edge can be configured to fix the limbs of the conductor elements inserted into the holding segment unit, in particular in a clamping manner, after the fitting of the holding segment unit with conductor elements.

In particular, the guide edge can be arranged along a comb tooth. In other words, the guide edge can run along, i.e. in the longitudinal direction, of a comb tooth. The guide edge can be arranged between two adjacent comb teeth.

If the holding segment units with the conductor elements located therein are moved into the final position, the conductor elements form the desired final configuration. In the final position, the holding segment units can be arranged overlapping one another. For this purpose, each holding segment unit can have a first overlap region and a second overlap region. The holding segment units can be arranged in the final configuration such that the first overlap region of a first holding segment unit overlaps with the second overlap region of an adjacent second holding segment unit. In other words, the overlap regions are arranged in particular in succession in a radial direction. A radial direction means a direction proceeding from the center point and pointing away from the center point.

In particular, the holding segment units overlap with their first and second overlap regions in such a way that the holding segment units are arranged in a scale-like manner along the second circular path.

The first overlap region can adjoin a first shoulder of the holding segment unit. Alternatively or additionally, the second overlap region can adjoin a second shoulder of the holding segment unit. The first and/or the second shoulder can be designed to merge into one another in steps or continuously (rounded). The first shoulder can be arranged on the side of the holding segment unit facing the center point. The second shoulder can be arranged at the side of the holding segment unit facing away from the center point.

Due to the first shoulder, the first overlap region is arranged radially outwardly offset on the holding segment unit in the radial direction, that is to say away from the center point.

Due to the second shoulder, the second overlap region is arranged offset radially inward against the radial direction, i.e. toward the center point, on the holding segment unit.

At least two adjacent, in particular all, holding segment units can be composed by the two shoulders. The holding segment units can in particular be assembled into a circle.

It is conceivable that all the holding segment units can be designed identically. In particular, the first overlap region can be designed to be complementary to the second overlap region. In particular, the first overlap region of a holding segment unit can be designed to be complementary to the second overlap region of an adjacent holding segment unit.

The apparatus can further comprise a first rotary table. The holding segment units can be arranged on the first rotary table.

The holding segment units can be designed to be movable by means of a slotted drive. For this purpose, the holding segment units can be arranged on a first, in particular (circular) round, base disk. The slotted drive can have a plurality of curved slot paths arranged on a circular path. The slot paths can be arranged on a disk-like slotted element. The slotted element can be arranged downstream of the base disk in the direction of gravity. In other words, the slotted element can be arranged below the base disk. Each holding segment unit can have an extension. The extensions of the holding segment units can be designed to engage in a corresponding slot path of the slotted element. The holding segment units can each be guided in a guide device. The guide device can be designed in the form of a straight groove or a guide rail in the base disk.

On the one hand, the extension of the element to be moved can be moved along the corresponding slot path by a rotation of the slotted element. On the other hand, the corresponding holding segment unit to be moved can be forced along a straight path by the corresponding guide device. A rotational movement (of the slotted element) can thus be transformed into a linear movement (of the holding segment units).

In particular, the slotted drive is designed and coupled to the holding segment units in such a way that it is moved along its corresponding movement path, in particular between the start and final positions, by a rotation of the slotted element.

The base disk and the slotted element (and/or the slotted drive) can be designed as a component of the first rotary table.

The apparatus can have at least one fixedly arranged special holding segment unit which is arranged immovably in the final position on the second circular path around the center point. The special holding segment unit can be designed analogously to the movable, above-described holding segment units, with the difference that it is designed to be immovable. In particular, the special holding segment unit is configured to receive special pins.

Furthermore, the object to be achieved is achieved by a machine having the features of claim 10, wherein the machine comprises at least one apparatus according to the above embodiments.

With regard to the advantages that can be achieved with the machine, reference is made to the statements relating to the apparatus in this respect. The measures described in connection with the machine can serve for developing the apparatus.

The machine comprises at least one fitting device for fitting the holding segment units of the apparatus in the starting position with conductor elements. The fitting device can in particular be designed based on a gripper.

The machine can comprise at least two of the apparatuses described at the outset. The apparatuses can be configured to transfer the conductor elements inserted in the corresponding apparatus into different final configurations.

The different final configurations of the conductor elements can have a different diameter. It is also conceivable that the different final configurations have a different number of conductor elements, a different type (hairpins, special pin) of the conductor elements, and/or a different size of the conductor elements.

The plurality of apparatuses of the machine can be arranged on a second rotary table.

Different stations can be realized on the second rotary table. For example, the fitting device could constitute a fitting station.

The holding segment units of an apparatus can be fitted with conductor elements on the fitting station. It is conceivable that, after the fitting of a holding segment unit, the first rotary table on which the holding segment units can be arranged is rotated further by one step, so that a subsequent (unfitted) holding segment unit can be moved toward the fitting device of the fitting station, and can be fitted with conductor elements by means of the fitting device. As soon as all the holding segment units are fitted with conductor elements by means of the fitting device, the apparatus can be conveyed to a subsequent station by means of a rotation of the second rotary table.

A further station can be a combining station. It is conceivable that at this station, the conductor elements, as described above, are combined to form the desired final configuration.

It is also conceivable that the combining of the conductor elements into the desired final configuration already begins by means of the second rotary table during the transport of the apparatus fitted with the conductor elements from the fitting station to the combining station, and is continued and terminated at the combining station.

Alternatively, the conductor elements can be combined into the desired final configuration during the transport of the apparatus fitted with the conductor elements by means of the second rotary table from the fitting station to a subsequent station, so that the conductor elements are already arranged in the desired final configuration when the apparatus reaches the subsequent station.

In addition, a removal station can be provided. At the removal station, the conductor elements transferred into the final configuration can be removed from the apparatus.

It is also conceivable for the apparatuses to be arranged as separate units, for example side by side. Each apparatus can have a separate fitting device.

Furthermore, the object to be achieved is achieved by a method having the features of claim 12, for producing an, in particular circular, final configuration of conductor elements, preferably hairpins, which are designed in particular with a rectangular conductor cross-section, for fitting a stator core, wherein each conductor element has at least one, in particular two, limbs, wherein the method comprises the steps of:

Arranging the conductor elements in a starting position, in particular in curved, conductor element segments. In this case, the conductor element segments are arranged at a corresponding first radial distance from a center point.

In particular, the conductor element segments can be arranged on a first circular path (i.e., at the same first radial distance from the center point) around the center point. It is also conceivable that the conductor element segments can each be arranged at a different distance from the center point.

Simultaneously moving the conductor element segments radially inward out of the starting position into a final position, wherein the conductor element segments are arranged in the final position in the final configuration. Alternatively, at least two conductor element segments, in particular all conductor element segments, can be moved in a temporally offset manner, i.e. one after the other, from the starting position radially inward into the final position. It is also conceivable for at least two conductor element segments to be moved at the same time, and for at least one conductor element to be moved radially inwards in a temporally offset manner from the starting position into the final position.

In this case, the conductor elements are moved from the starting position into the final position on a, at least partially straight and/or at least partially curved, movement path.

The conductor element segments can be moved translationally from the starting position into the final position exclusively in a straight line. The conductor element segments can be moved in a straight-line. In other words, the conductor element segments can be guided during their linear movement.

The conductor element segments can each be moved on a movement path between their starting position and their final position. The movement paths of the conductor element segments can run tangentially to a third circular path around the center point or through the center point. If at least three conductor element segments are moved, their corresponding movement path can run tangentially to a third circular path around the center point. In other words, the movement paths of the conductor element segments do not run in particular through the center point. In particular, the diameter of the third circular path is always greater than zero. If (exclusively) two conductor elements are moved, their corresponding movement path can run through the center point.

The method may comprise the step of:

Arranging the conductor elements in a final position in at least one, in particular arcuate, immovable conductor element segment. In particular, the conductor elements are arranged in the immovable conductor element segment in the final configuration.

In order to carry out the method, an apparatus according to the above embodiments or a machine according to the above embodiments can be used.

With regard to the advantages that can be achieved with the method, reference is made to the statements in this regard relating to the apparatus or the machine. The measures described in connection with the apparatus or the machine can serve for developing the method.

Further features, details and advantages of the invention emerge from the wording of the claims and from the following description of exemplary embodiments with reference to the drawings. In the drawings:

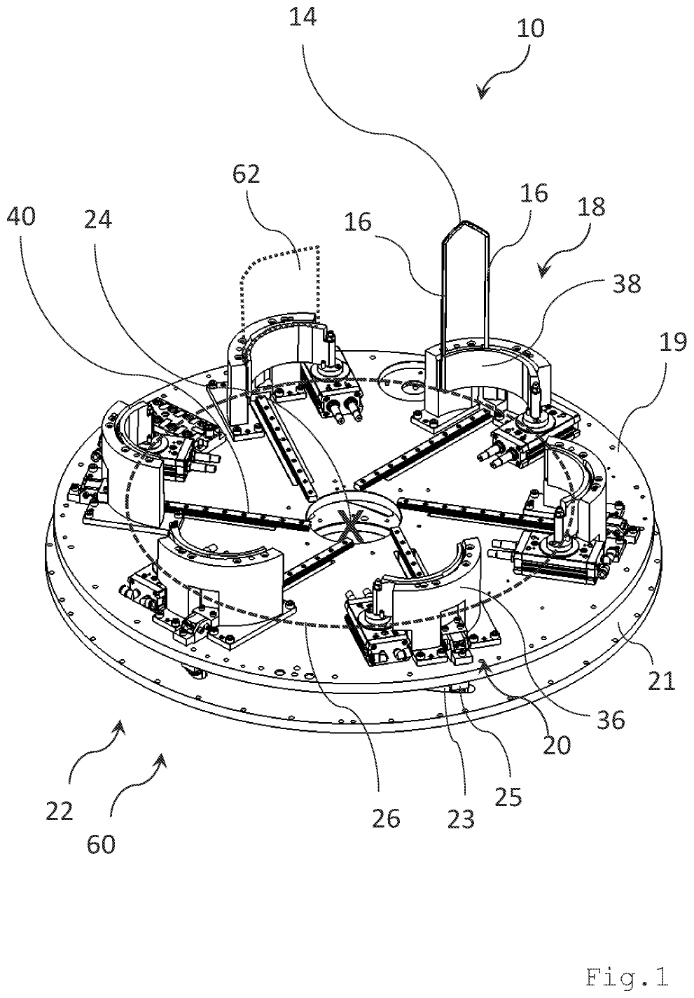

FIG. 1 is a perspective view of an apparatus according to the invention in a first state,

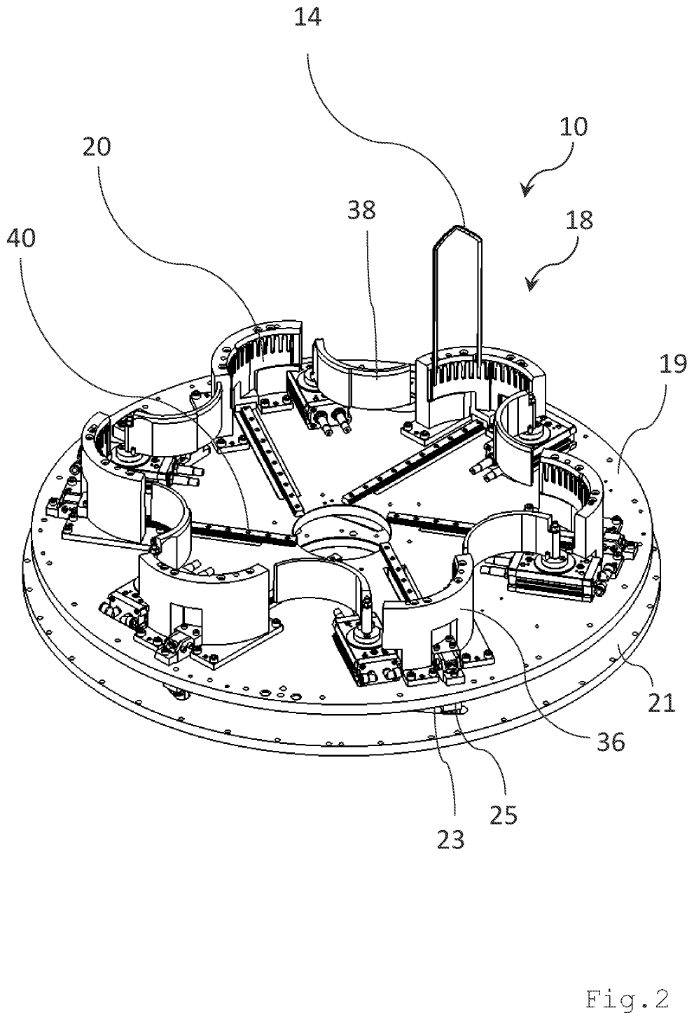

FIG. 2 is a perspective view of the apparatus according to FIG. 1 in a second state;

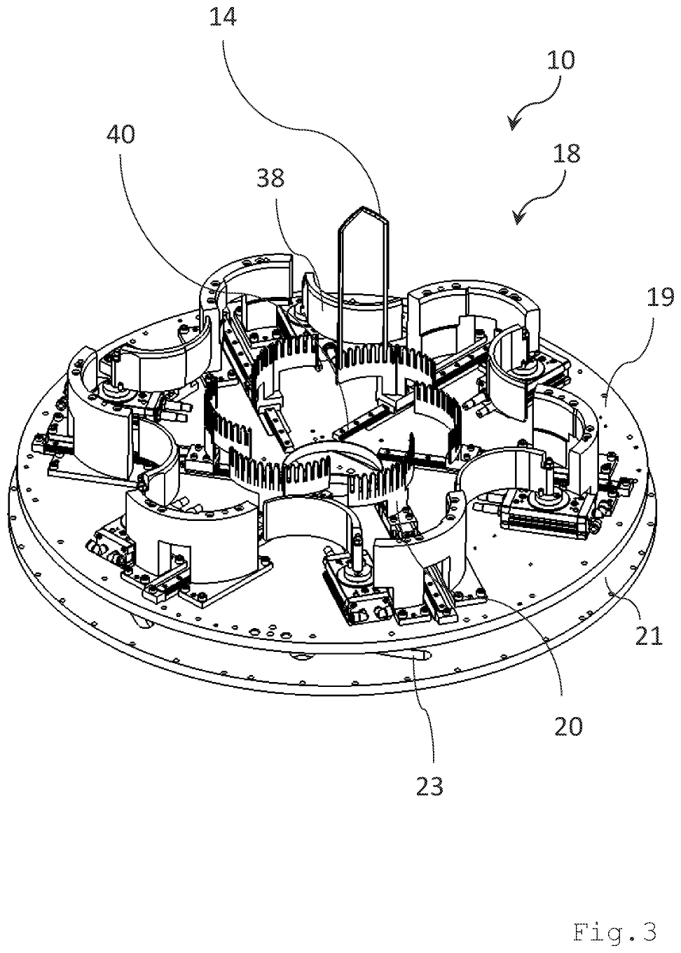

FIG. 3 is a perspective view of the apparatus according to FIG. 1 in a third state;

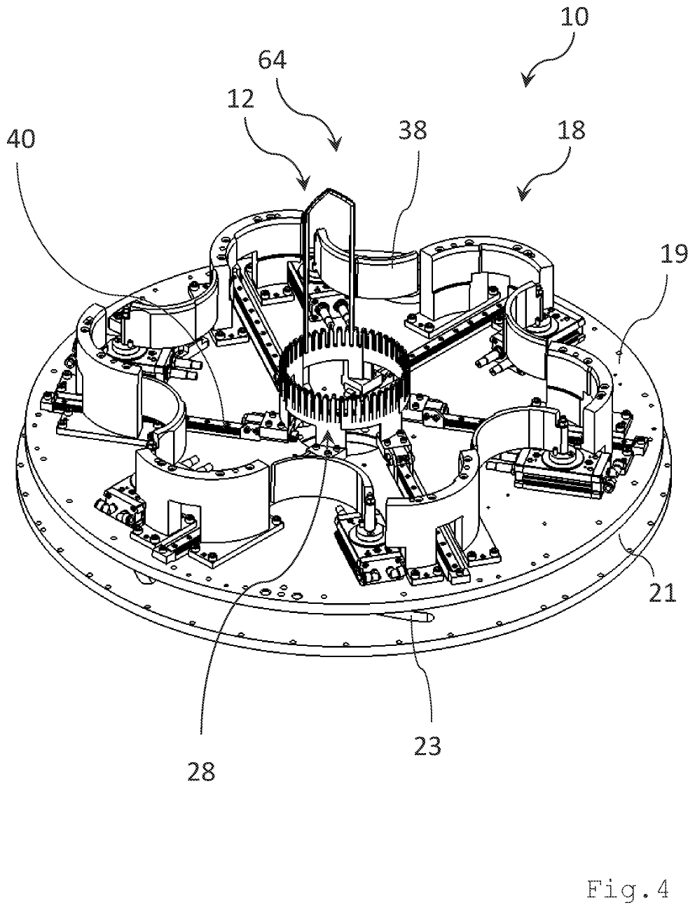

FIG. 4 is a perspective view of the apparatus according to FIG. 1 in a fourth state;

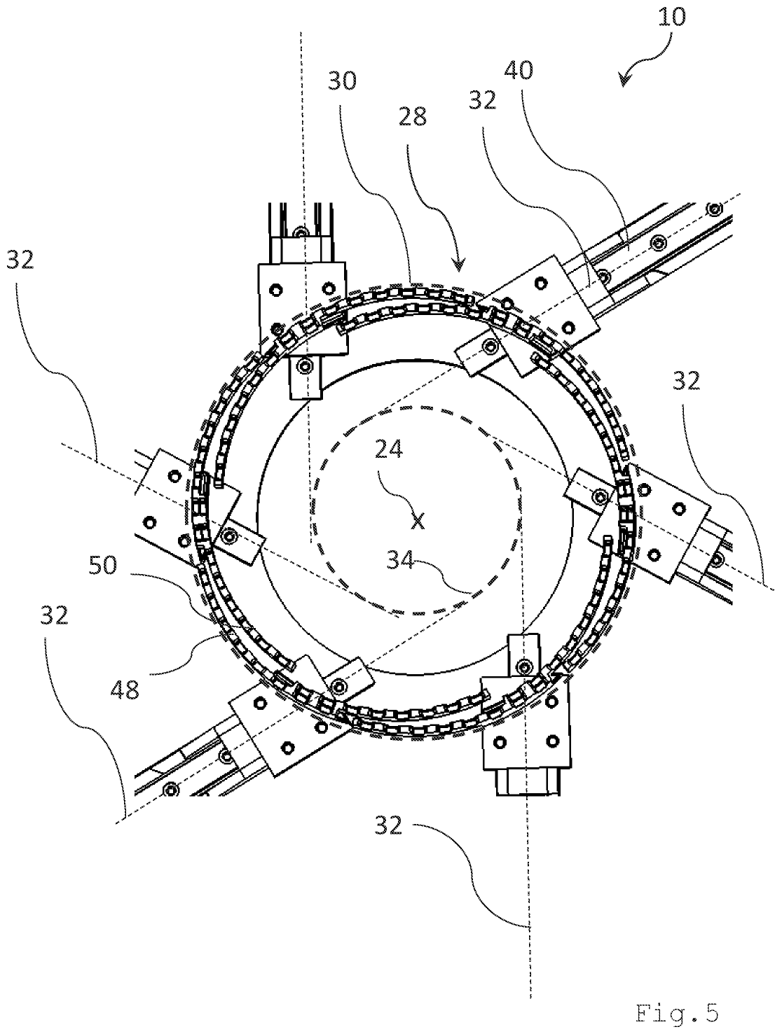

FIG. 5 is a detail of a plan view of the apparatus according to FIG. 4,

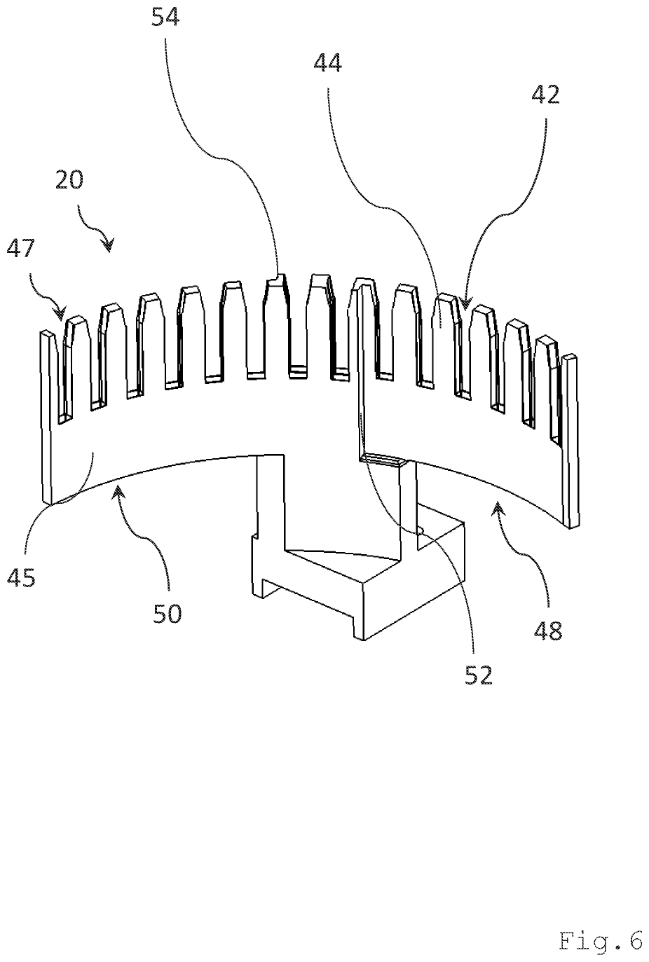

FIG. 6 is a perspective view of a holding segment unit according of the apparatus according to FIG. 1;

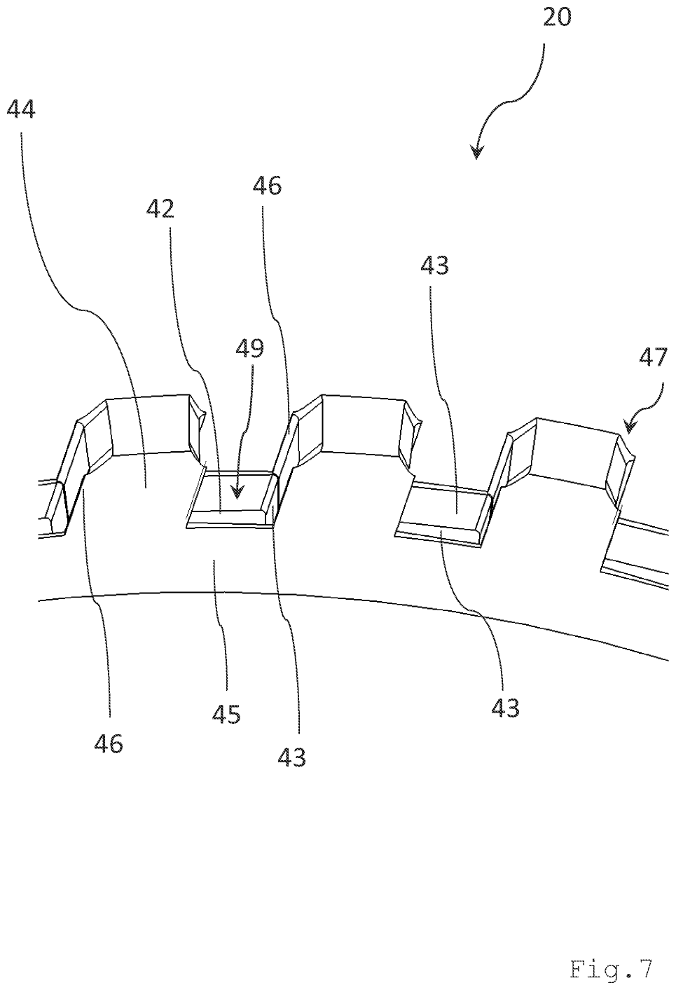

FIG. 7 is a detail of a perspective view of the holding segment unit according to FIG. 6,

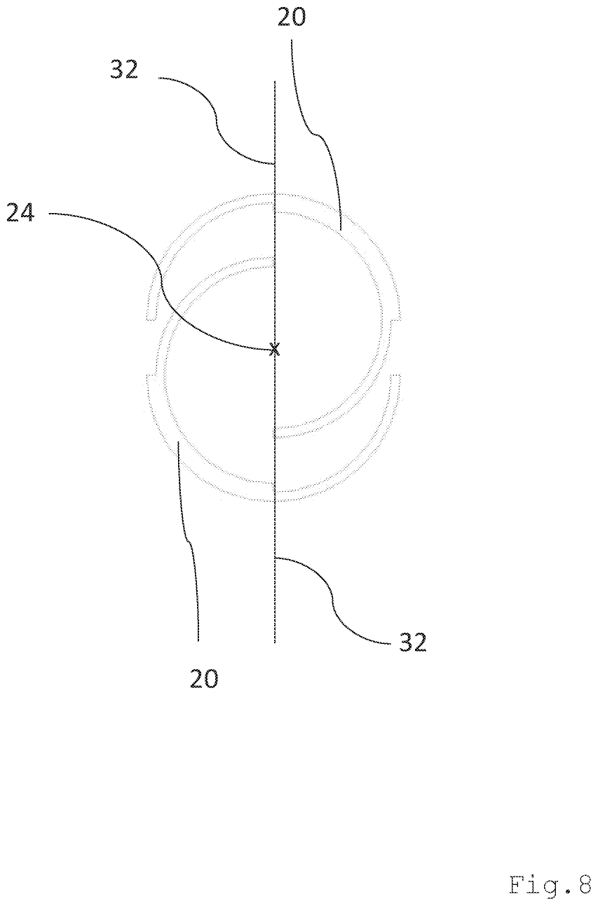

FIG. 8 is a schematic representation of the apparatus with two holding segment units;

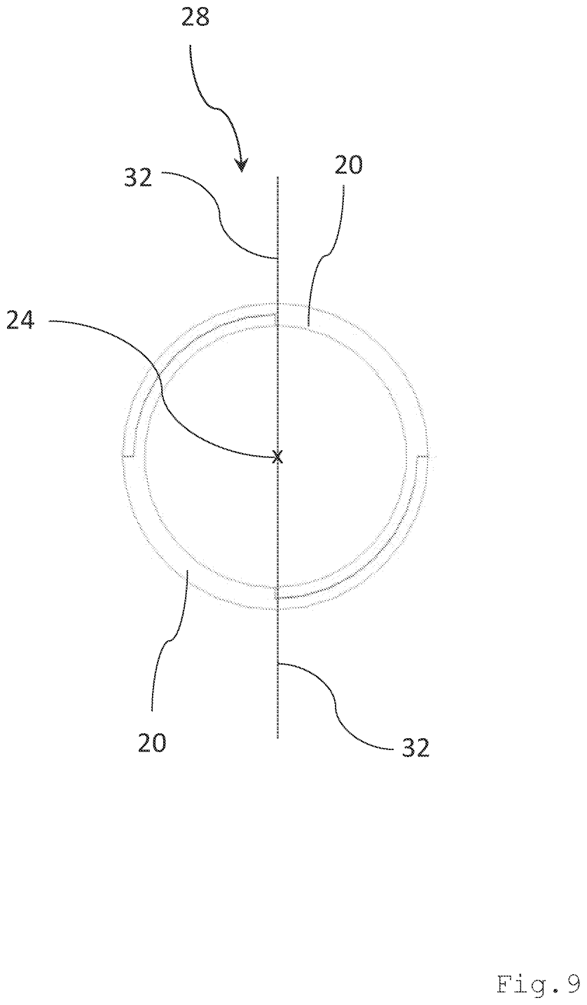

FIG. 9 is a schematic view of the apparatus according to FIG. 8, with two holding segment units in the final position;

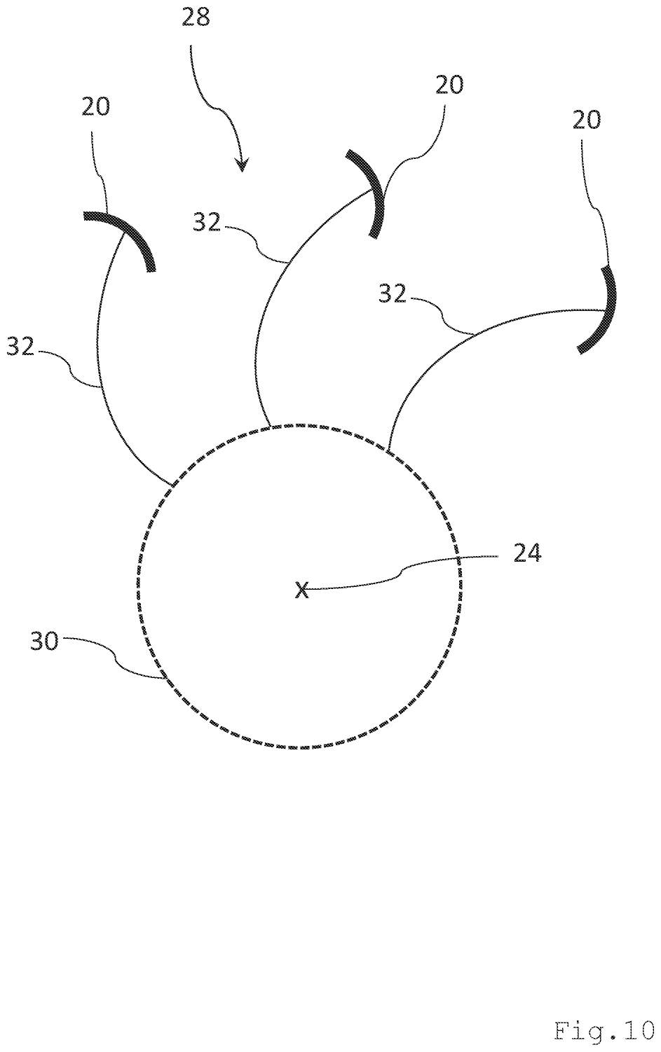

FIG. 10 is a schematic representation of an apparatus with curved movement paths, and

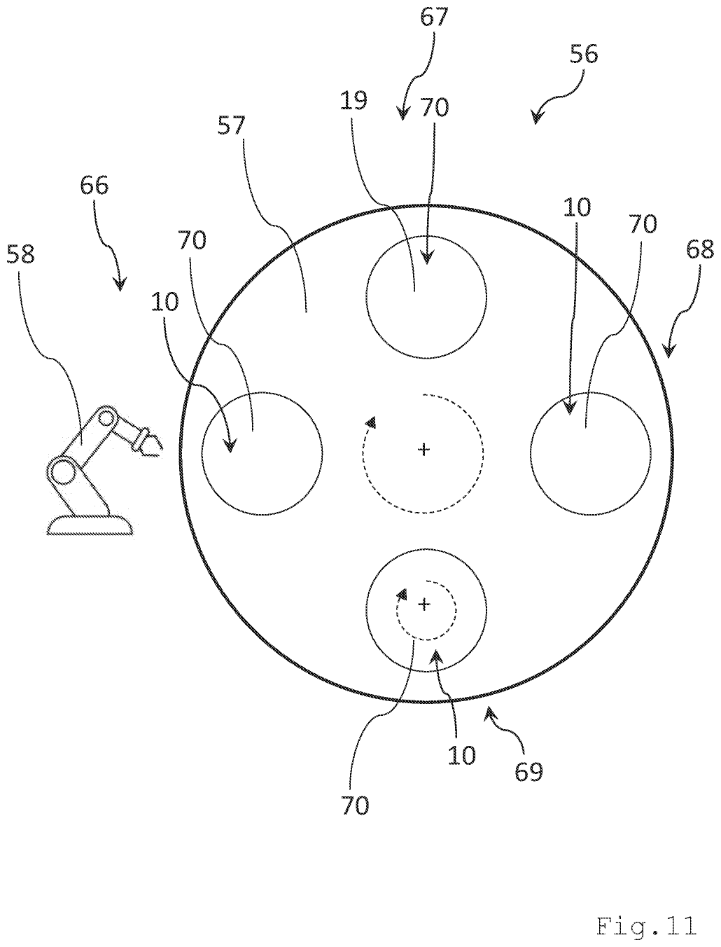

FIG. 11 is a schematic representation of a machine according to the invention.

In the following description and in the figures, corresponding components and elements bear the same reference signs. For improved clarity, not all reference signs are reproduced in all figures.

FIG. 1 is a perspective view of an apparatus 10 according to the invention in a first state. In the present case, a circular final configuration 12 of conductor elements 14 (see FIG. 4) can be achieved by means of the apparatus 10. Each conductor element 14 has at least one or two limbs 16.

The apparatus 10 in the present case has six holding segment devices 18. The holding segment devices 18 are arranged uniformly distributed on a disk-shaped base disk 19.

Each holding segment device 18 has a holding segment unit 20. Each holding segment unit 20 holds a plurality of conductor elements 14. All limbs 16 of the held conductor elements 14 are in each case held (received) in the holding segment unit 20 in a fixed manner.

The holding segment units 20 are designed to be movable. In the present case, the holding segment units 20 are moved by means of a slotted drive. A disk-shaped slotted element 21 is arranged below the base disk 19 for this purpose. The slotted element 21 has six curved slot paths 23 (corresponding to the number of holding segment units). Each holding segment unit 20 has an extension 25 which engages in the corresponding slot path 23.

The holding segment devices 18 each have a guide rail 40. Each holding segment unit 20 is designed to be movable along the corresponding guide rail 40. The guide rails 40 are arranged on the base disk 19. If the slotted element 21 is now rotated, the extension 25 of each holding segment unit 20 is guided in the corresponding slot path 23. In addition, each holding segment unit is forced by means of the guide rails 40 to a movement along the guide rails 40. The holding segment units 20 can thus be moved along the guide rails 40 by means of a rotational movement of the slotted element 21.

The conductor elements 14 are arranged as conductor element segments 62 in the holding segment units 20. In other words, a plurality of conductor elements 14 form an arcuate conductor element segment 62 which is held in a holding segment unit 20. In the present case, only one conductor element 14 is shown for reasons of clarity. Likewise for reasons of clarity, the conductor element segments 62 are not shown, and are only indicated by dashed lines on one holding segment unit 20.

The holding segment units 20 are arranged in a starting position 22 in FIG. 1. In this starting position 22, the holding segment units 20 are fitted with conductor elements 14. A fitting device 58 can be provided for this purpose (see below). The conductor element segments 62 are also arranged in a starting position 60 in FIG. 1.

In the present case, the holding segment units 20 are arranged in the starting position 22 as a circle around a center point 24. The holding segment units 20 each have an identical distance from the center point 24. In other words, the holding segment units 20 are arranged on a first circular path 26 around the center point 24.

Each holding segment device 18 has a first guide element 36 and a second guide element 38. In the present case, the first guide elements 36, the second guide elements 38, and the holding segment units 20 have a curved (circular segment-like) shape.

Each holding segment unit 20 is arranged in its starting position 22 between the first guide element 36 and the second guide element 38. In other words, the two guide elements 36, 38 fix the holding segment unit 20 in a clamping manner.

The first guide elements 36 are arranged at the sides of the holding segment units 20 facing away from the center point 24. In the present case, the first guide elements 36 are arranged fixedly on the base disk 19. In other words, the first guide elements 36 are immovable relative to the base disk 19.

The second guide elements 38 are arranged on the sides of the holding segment units 20 facing the center point 24. In the present case, the second guide elements 38 are arranged pivotably on the base disk 19. In this case, the second guide elements 38 can be pivoted into a first fitting position (shown in FIG. 1).

In the illustrated state, the second guide elements 38 are in the fitting position. In other words, the second guide elements 38 are pivoted closed, so that a movement of the holding segment units 20 directed radially inward (in the direction of the center point 24) is not possible.

In the fitting position, the second guide elements 38 (and the first guide elements 36) form a guide for conductor elements 14 to be fitted. In the fitting position, the second guide elements 38 block a radially inward movement of the holding segment units 20.

The second guide elements 38 can be pivoted into a release position (shown in FIG. 2). In the release position, the second guide elements 38 release the holding segment units 20 (or the radially inwardly directed path), so that holding segment units 20 can move radially inward (in the direction of the center point 24).

The holding segment units 20 can be moved radially inwards from the starting position 22 shown in FIG. 1 along the guide rails 40. The guide rails 40 serve as a guide for the holding segment units 20.

FIG. 2 is a perspective view of the apparatus 10 according to FIG. 1 in a second state. In the shown state, the second guide elements 38 are in the release position. In other words, the second guide elements 38 are pivoted open, so that a movement of the holding segment units 20 along the corresponding guide rails 40 is possible.

FIG. 3 is a perspective view of the apparatus 10 according to FIG. 1 in a third state. In the third state shown, the holding segment units 20 have already moved a step radially inward along the corresponding guide rails 40.

FIG. 4 is a perspective view of the apparatus 10 according to FIG. 1 in a fourth state. In the shown state of the apparatus 10, the holding segment units 20 are in a final position 28. In the final position 28, the conductor elements 14 are combined to form the desired final configuration 12.

The holding segment units 20 can be moved (transferred) along the corresponding guide rails 40 from the starting position 22 into the final position 28. In other words, the holding segment units 20 are designed to be movable between the starting position 22 and the final position 28.

In the illustrated state, the conductor element segments 62 (not shown) are also located in their final position 64 and form the desired final configuration 12 of the conductor elements 14. The conductor element segments 62 can be moved between their starting position 60 and their final position 64 (along the guide rails 40). In the present case, this takes place by means of the corresponding holding segment units 20.

In the shown state, the second guide elements 38 continue to be in their release position. In other words, the second guide elements 38 are further pivoted open.

FIG. 5 shows a detail of a plan view of the apparatus 10 according to FIG. 4. The holding segment units 20 are arranged in their final position 28. In the present case, the holding segment units 20 are arranged on a second circular path 30 around the center point 24. In other words, the distance between each holding segment unit 20 and the center point 24 is in each case the same.

Each holding segment unit 20 moves on its guide rail 40 along a movement path 32. The guide rail 40 corresponds to the corresponding movement path 32. In other words, each guide rail 40 is arranged parallel to the corresponding movement path 32 or is identical to the corresponding movement path 32. The movement paths 32 are each shown by means of a dashed line.

The movement paths 32 run tangentially to a third circular path 34 around the center point 24. The third circular path 34 is always greater than zero. In other words, the movement paths 32 do not run through the center point 24.

FIG. 6 is a perspective view of a holding segment unit 20 of the apparatus 10 according to FIG. 1. The holding segment unit 20 is designed in an arc-like manner. The holding segment unit 20 has a plurality of receptacles 42. These serve to receive limbs 16 of a conductor element 14.

The holding segment unit 20 is comb-like. In other words, the holding segment unit 20 is designed in the form of a comb with comb teeth 44 and comb spine 45.

Each receptacle 42 of the holding segment unit 20 is arranged between two adjacent comb teeth 44. The comb teeth 44 are elongated and straight (pin-like) and have a tapering portion 47 at their end facing away from the chamber spine 45. The tapered portion 47 facilitates the insertion of the conductor elements 14 to be fitted into the receptacles 42.

The holding segment unit 20 has a first overlap region 48 and a second overlap region 50. The first overlap region 48 adjoins a first shoulder 52 of the holding segment unit 20. The second overlap region 50 adjoins a second shoulder 54 of the holding segment unit 20. Both shoulders 52, 54 are designed to be step-shaped.

In other words, the first overlap region 48 and the second overlap region 50 are arranged offset to one another in the radial direction. The first overlap region 48 and the second overlap region 50 are formed complementary to each other. It is also conceivable that the first overlap region 48 of a holding segment unit 20 is designed to be complementary to the second overlap region 50 of an adjacent holding segment unit 20.

In the final position 28 of the holding segment units 20, the first overlap region 48 of a first holding segment unit 20 overlaps with the second overlap region 50 of a second holding segment unit 20 adjacent to the first holding segment unit 20.

The holding segment units 20 overlap in the corresponding overlap regions 48, 50, wherein the overlap of the overlap regions 48, 50 extends from the first shoulder 48 of the first holding segment unit 20 up to the second shoulder 50 of the second holding segment unit 20 adjacent to the first holding segment unit 20 (cf. FIG. 5).

FIG. 7 shows a detail of a perspective view of the holding segment unit 20 according to FIG. 5. As can be clearly seen in FIG. 7, the receptacles 42 are each spatially delimited by five walls 43. In each case, three adjacent walls 43 are arranged perpendicular to one. The receptacles 42 are therefore pocket-shaped.

The five walls 43 of a receptacle 42 spatially delimit the receiving space 49. In the present case, the receiving space 49 is substantially cuboid. A different shape of the receptacles 52 and/or of the corresponding receiving space 49, for example cylindrical (e. g., for conductor elements having a round cross-section), is also conceivable.

The holding segment unit 20 here has multiple guide edges 46. A plurality of guide edges 46 are arranged at a side of the holding segment unit 20 facing the center point 24. A plurality of guide edges 46 are also arranged at a side of the holding segment unit 20 facing away from the center point 24.

A guide edge 46 is arranged between each two adjacent comb teeth 44 and along each comb tooth 44. In other words, a guide edge 46 is arranged along the longitudinal extension of each comb tooth 44, wherein said guide edge is arranged between two adjacent comb teeth 44.

Four guide edges 46 are thus arranged between two adjacent comb teeth 44. These are arranged projecting obliquely into the space between the comb teeth 44. They thus form a guide when the conductor elements 14 or the limbs 16 of the conductor elements 14 are inserted into the corresponding receptacles 42.

FIG. 8 shows a schematic illustration of the apparatus 10 with two holding segment units 20. Unlike the embodiment of the apparatus 10 shown in FIGS. 1 to 5, the movement paths 32 of the two holding segment units 20 run in a straight line through the center point 24. In the present case, the course of the two movement paths 32 of the two holding segment units 20 is identical. In the state shown, the two holding segment units 20 are arranged at a distance from one another.

FIG. 9 is a schematic illustration of an apparatus 10 according to FIG. 8 in another state. In the state shown, the holding segment units 20 are arranged in the final position 28. The two holding segment units 20 form a circular structure in the final position 28.

FIG. 10 shows a schematic illustration of the apparatus 10 with curved movement paths 32. In the present case, the holding segment units 20 are arranged in the starting position 22 in a circular manner around the center point 24, wherein, for reasons of clarity, the holding segment units 20 are only shown by means of three holding segment units 20. The holding segment units 20 move on curved movement paths 32 from the shown starting position 22 into the final position 28. In the final position 28, the holding segment units 20 are arranged on the second circular path 30 around the center point 24.

FIG. 11 shows a schematic view of a machine 56 according to the invention. The machine 56 has a second rotary table 57. Four apparatuses 10 described above are arranged on the second rotary table 57 in the present case.

Each of the four apparatuses 10 is arranged rotatably on the second rotary table 57 by means of a first rotary table 70. In particular, the base disk 19 of the corresponding apparatus 10 forms the surface of the corresponding first rotary table 57.

Each of the four apparatuses 10 can be moved by a rotation of the second rotary table 57 toward the fitting device 58. There, the apparatus 10 can be fitted with conductor elements 14 by means of the fitting device 58. Subsequently, the second rotary table 57 can be further rotated, so that the subsequent apparatus 10 can be moved to the fitting device 58.

As soon as an apparatus 10 has been fitted with conductor elements 14 and is moved further (rotated) by means of the second rotary table 57, the above-described combining of the conductor elements 14 into the final configuration 12 can be implemented. It is also conceivable that the above-described combining of the conductor elements 14 into the final configuration 12 is implemented at predetermined positions (rotational positions) of the second rotary table 57.

It is conceivable that, in at least one position (rotational position) of the second rotary table 57, the conductor elements 14 combined in the final configuration 12 are removed from the apparatus 10 or the machine 56.

Various stations are realized in the present case on the second rotary table. In the present case, the fitting device 58 represents a fitting station 66 on which the corresponding apparatus 10 located on the fitting station 66 can be fitted with conductor elements 14. After the fitting station 66, a combining station 67 follows in the clockwise direction, on which the conductor elements 14 are transferred into their final configuration 12 as described above.

After the combining station 67, a removal station 68 follows in the clockwise direction for removing the conductor elements 14 transferred into the final configuration 12 from the corresponding apparatus 10.

After the removal station 68, a return station 69 follows in the clockwise direction for returning the holding segment units 20 to their starting position 22. In this case, the second guide elements 38 can be pivoted back into their corresponding fitting position so that the apparatus 10 can again be provided for fitting with conductor elements 14.

1. An apparatus (10) for producing an in particular circular final configuration (12) of conductor elements (14), preferably hairpins, which are designed in particular with a rectangular conductor cross-section, for fitting a stator core, wherein each conductor element (14) has at least one, in particular two, limbs (16), wherein the apparatus (10) comprises:
at least two holding segment devices (18), wherein each holding segment device (18) has at least one holding segment unit (20), which is configured to receive the limbs (16) of a plurality of conductor elements (14) and to hold them in an intended orientation, and to transfer them into the final configuration (12) by moving the holding segment unit (20),
wherein all limbs of a conductor element (14) held in the holding segment unit (20) are held in the holding segment unit (20),
wherein the holding segment units (20) are arranged in a starting position (22), in particular on a first circular path (26) around the center point (24), at a corresponding first radial distance from a center point (24),
wherein the holding segment units (20) in a final position (28) are arranged on a second circular path (30) around the center point (24),
wherein at least one, in particular a plurality of, in particular each, holding segment unit (20) is designed to be movable along an at least partially straight movement path (32) between the starting position (22) and the final position (28) in the apparatus (10), so as to move the conductor elements (14) held therein from the starting position (22) into the final position (28),
wherein the movement paths (32) of the holding segment units (20) run tangentially to a third circular path (34) around the center point (24) or through the center point.

2. The apparatus according to claim 1, characterized in that each holding segment unit (20) is designed to be movable along a straight movement path (32) between the starting position (22) and the final position (28) in the apparatus (10), so as to move the conductor elements (14) held therein from the starting position (22) into the final position (28) by means of an exclusively straight, translational movement.

3. The apparatus (10) according to claim 1, characterized in that each holding segment device (18) comprises a first guide element (36) and a second guide element (38), wherein the corresponding holding segment unit (20) is arranged in the starting position (22) between the first guide element (36) and the second guide element (38), wherein the first and the second guide element (36, 38) are configured such that the conductor elements (14) are guided at least partially through the guide elements (36, 38) when fitting the corresponding holding segment unit (20) in the starting position (22).

4. The apparatus (10) according to claim 3, characterized in that the second guide element (38) is arranged on the side of the holding segment unit (20) that faces the center point (24), and is movable, in particular pivotable, in such a way that it can be moved between a fitting position in which it fixes the holding segment unit (20) and forms a guide for conductor elements to be fitted, and a release position in which a movement of the holding segment unit (20) into its final position (28) is possible.

5. The apparatus (10) according to claim 1, characterized in that each holding segment device (18) comprises at least one guide device, in particular in the form of a guide rail (40), for the guided movement of the holding segment unit (20) along the movement path (32), in particular between the starting position (22) and the final position (28).

6. The apparatus (10) according to claim 1, characterized in that each holding segment unit (20) has a plurality of receptacles (42) for receiving limbs (16) of a conductor element (14), in particular wherein the holding segment unit (20) is comb-like in design, wherein each receptacle (42) is arranged between two adjacent comb teeth (44).

7. The apparatus (10) according to claim 6, characterized in that each holding segment unit (20) has at least one guide edge (46), wherein the guide edge (46) is configured to at least partially guide and center the conductor elements (14) to be inserted into the holding segment unit (20) during the fitting of the holding segment unit (20), in particular wherein the guide edge (46) is arranged along a comb tooth (44) and between two adjacent comb teeth (44).

8. The apparatus (10) according to claim 1, characterized in that each holding segment unit (20) has a first overlap region (48) and a second overlap region (50), wherein the holding segment units (20) are arranged in the final configuration (12) such that the first overlap region (48) of a first holding segment unit (20) overlaps with the second overlap region (50) of an adjacent second holding segment unit (20), in particular wherein the first overlap region (48) adjoins a first shoulder (52) of the holding segment unit (20) and/or the second overlap region (50) adjoins a second shoulder (54) of the holding segment unit (20).

9. The apparatus (10) according to claim 1, characterized in that the apparatus has at least one fixedly arranged special holding segment unit which is arranged immovably in the final position (28) on the second circular path (30) around the center point (24).

10. A machine (56) comprising at least one apparatus (10) according to claim 1, characterized in that the machine (10) comprises at least one fitting device (58) for fitting the holding segment units (20) of the apparatus (10) in the starting position (22) with conductor elements (14), wherein the fitting apparatus (58) is designed in particular based on a gripper.

11. The machine (56) according to claim 10, characterized in that the machine (56) comprises at least two apparatuses (10) according to, wherein the apparatuses (10) are configured to transfer the conductor elements (14) inserted in the corresponding apparatus (10) into different final configurations (12), in particular wherein the different final configurations (12) of the conductor elements (14) have a different diameter.

12. A method for producing an in particular circular final configuration (12) of conductor elements (14), preferably hairpins, which are designed in particular with a rectangular conductor cross-section, for fitting a stator core, wherein each conductor element (14) comprises at least one, in particular two, limbs (16), wherein the method comprises the steps of:
arranging the conductor elements (14) in a starting position (60) in, in particular curved, conductor element segments (62), wherein the conductor element segments (62) are arranged at a corresponding first radial distance from a center point (24), in particular on a first circular path (26) around the center point (24);
wherein each conductor element segment (62) is held in a holding segment unit (20), wherein all limbs (16) of a conductor element segment (62) held in the holding segment unit (20) are held in the holding segment unit (20);
simultaneously and/or asynchronously moving the conductor element segments (62) radially inward out of the starting position (60) into a final position (64), wherein the conductor element segments (62) are arranged in the final position (64) in the final configuration (12),
wherein the conductor element segments (62) are moved from the starting position (60) into the final position (64) on a, at least partially straight, movement path.

13. The method according to claim 12, characterized in that the conductor element segments (62) are moved translationally from the starting position (60) into the final position (64) exclusively in a straight line.

14. The method according to claim 12, characterized in that the conductor element segments (62) are each moved on a movement path (32) between the starting position (60) and the final position (64), wherein the movement paths (32) of the conductor element segments (62) run tangentially to a third circular path (34) around the center point (24) or through the center point (24).

15. The method according to claim 12, characterized in that the method comprises the step of:
arranging the conductor elements (14) in a final position (64) in at least one, in particular arcuate, immovable conductor element segment.

16. (canceled)
